(19) United States
(12) Patent Application Publication
(10) Pub. No.: US 2008/0093377 A1
(43) Pub. Date: Apr. 24, 2008

(54) DISPENSING DEVICE FOR CONTAINERS

(76) Inventor: Mehran Dadbeh, West Vancouver (CA)

Correspondence Address: OYEN, WIGGS, GREEN & MUTALA LLP;480 - THE STATION, 601 WEST CORDOVA STREET, VANCOUVER, BC, V6B 1G1, US

(21) Appl. No.: 11/552,367

(22) Filed: Oct. 24, 2006

(51) Int. Cl. G01F 11/26

(52) U.S. Cl. 221/288

(57) ABSTRACT

A dispensing device relocates at least one object from a bottom portion of a container to a position located close to the opening of the container to allow the object to be easily removed. The device comprises an elongate body member and a plurality of teeth extending outwardly from an inner surface of the body member. When the device is inserted into a container, an outer surface of the body member extends at least partially around an inside wall of the container, at least a portion of the outer surface engages the inside wall in a friction fit, and the plurality of teeth form a shelf. An opening is defined between the shelf and the container. When the container is inverted, at least one object passes through the opening and is retained on the shelf when the container is at least partially righted.

### TECHNICAL FIELD

This invention relates to providing a device for dispensing at least one object from a container and for relocating objects from the bottom of a container to a position close to the opening of the container for easy removal of the objects.

### BACKGROUND

Many objects are stored in small cylindrical containers which are relatively long and narrow. When the container is full, the objects at the top are easily accessible. However, when the container is not full, such as is the case when the objects are small or when the objects stored in the container are consumed over time, it becomes increasingly difficult to access objects located near the bottom of the container.

This problem is illustrated by pills stored in standard pill containers. Many types of medication come in pill, capsule or tablet form and are sold in pill containers. For example, many types of prescription drugs are dispensed in standard cylindrical containers. Depending on the quantity and type of medication, the pill containers may be completely or partially filled. Usually, the containers are only partially filled.

There are two problems associated with the use of such containers. First, it is difficult to reach the pills when the container is not full and second, it is difficult to dispense only a small number of the pills at a time. Without the assistance of a dispenser, most people obtain the required number of pills by either reaching one or two fingers into the container and “digging” out the pills or by pouring a large number of pills into the palm of their hand, removing the desired number of pills and returning the rest of the pills back into the container. Both of these methods result in excessive handling of the pills, which can cause contamination of the pills. Both of these methods are also difficult for people who suffer from arthritis or other motor difficulties. Furthermore, during the process of obtaining or replacing the pills in the container, some of the pills may fall on the ground. The fallen pills may be picked up and consumed by young children or pets causing them potential harm.

U.S. Pat. No. 4,454,962 (Greenspan) discloses an insertable dispenser device for pill bottles. The device comprises a rigid annular body member with an aperture for the passage of pills and flexible lip members extending outwardly around the periphery of the body member to allow for a snug friction fit of the body member in a pill bottle. An annular shelf disposed on the inner circumference of the member serves to capture pills passing through the aperture. This dispenser device requires that the aperture be sized at least slightly larger than the diameter of the largest item desired to be dispensed. Because the annular shelf is distributed around the circumference of the body member, there will be situations where the shelf will provide inadequate support for retaining the pills. For example, in situations where the pills are large but the pill bottle is narrow, a relatively large aperture will be needed and this will result in a narrow annular shelf. This will make it difficult for the pills to be retained on the shelf; instead, most pills will fall back down through the aperture. Although this device may be used for a variety of different sizes of pills and pill bottles, the extent of this variability is limited by the size of the lip members and the aperture. Thus, a number of different size variations of the device are needed to accommodate different combinations of pill bottle sizes and pill sizes. This would be inefficient for pharmacies and other users who would need to keep many different sizes of the device on hand. It would also entail more work on the part of the user to determine which size variation would be best suited for a particular pill bottle/pill size combination. Finally, it is also conceivable that when the pill bottles are inverted and shaken, the weight of the pills may cause the device to move towards the opening of the pill bottle resulting in a decreased space between the opening and the annular shelf. This in turn decreases the amount of space available for retaining the pills on the annular shelf.

There remains a need for ways to relocate and dispense at least one pill or other object from a container.

### SUMMARY

A first aspect of this invention provides a device for dispensing at least one object from a container. The device has an elongate body member, the body member having an outer surface for following at least partially an inside wall of the container when the device is inserted into the container and having at least a portion of the outer surface engaging the inside wall of the container in a friction fit; and a plurality of teeth extending from an inner surface of the body member at spaced apart locations, the teeth extending in a substantially radial direction to form a shelf when the body member is inserted into the container, wherein an opening is defined between the shelf and the container when the device is inserted into the container, the opening sized to allow passage of the at least one object from a bottom portion of the container through the opening when the container is inverted and the at least one object being retained on the shelf when the container is at least partially righted.

In one embodiment of the invention, the body member is formed of a bendable resilient material such as plastic and is bendable to allow the body member to be inserted into the container.

The body member has opposed longitudinal peripheral edges and opposed side peripheral edges. The opposed edges may be straight, rounded or polygonal shape. At least one tab may be formed on a longitudinal peripheral edge of the body member, the tab extending outwardly from the inner surface of the body member and at least one lip portion may be formed on a longitudinal or side peripheral edge of the body member, the lip portion extending outwardly from the inner surface of the body member. A piping or solid portion may be formed on each of the side peripheral edges of the body member.

In one embodiment of the invention, the body member comprises a longitudinal portion, a plurality of first transverse portions extending from a first longitudinal peripheral edge of the longitudinal portion, and a plurality of second transverse portions extending from a second longitudinal peripheral edge of the longitudinal portion. In this instance, pairs of first and second transverse portions are transversely aligned, and the first and second transverse portions have different lengths. Tabs may be formed at end portions of at least one of the plurality of first transverse portion and at least one of the plurality of second transverse portions, the tabs extending outwardly from an inner surface of the end portions. The size of the device may be adjusted by removing a portion of the longitudinal portion adjacent one of the pairs of transversely aligned first and second transverse portions.

In one embodiment of the invention, the plurality of teeth are uniformly spaced apart, but they do not need to be. The teeth may be aligned along a longitudinal axis of the body member, which may be offset from a central longitudinal axis of the body member. The teeth may be of more than one length. The teeth may be perpendicular to the elongate body member or may be angled to form an upwardly sloping shelf when the device is inserted into the container.

### BRIEF DESCRIPTION OF DRAWINGS

In drawings which show non-limiting embodiments of the invention:

FIG. 1 is a perspective view of a dispensing device according to a particular embodiment of the invention;

FIG. 2 is a longitudinal side view of the FIG. 1 device;

FIG. 3 is a top plan view of the FIG. 1 device;

FIG. 4 is a transverse side view of the FIG. 1 device;

FIG. 5 is cross-sectional side view of a container with the FIG. 1 device inserted in the container;

FIG. 6 is a cross-sectional view taken along the line 6-6 of FIG. 5;

FIG. 7 is a perspective view of a dispensing device according to a second embodiment of the invention;

FIG. 8 is a longitudinal side view of the FIG. 7 device;

FIG. 9 is a top plan view of the FIG. 7 device;

FIG. 10 is a transverse side view of the FIG. 7 device;

FIGS. 11A, 11B and 11C are cross-sectional views showing the device of FIG. 1 or FIG. 7 placed in containers of various sizes; and

FIGS. 12A, 12B, 12C and 12D show alternative embodiments of the device shown in FIG. 1, having lips or other portions formed on various of the edges of the device.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

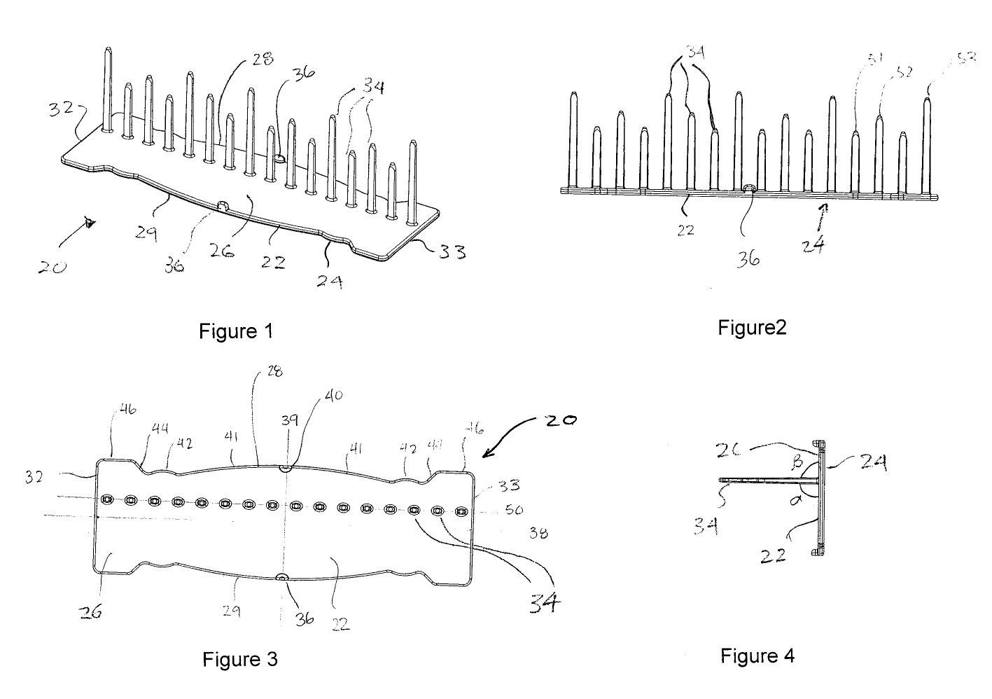

FIGS. 1-4 depict various views of a dispensing device 20 according to a particular embodiment of the invention. Dispensing device 20 comprises a generally elongate body member 22 having an outer surface 24, an inner surface 26, longitudinal peripheral edges 28, 29, and side peripheral edges 32, 33. Device 20 also comprises a plurality of teeth 34 extending from inner surface 26 at spaced apart locations. Device 20 also comprises one or more tabs 36 located along longitudinal peripheral edges 28, 29.

In the illustrated embodiment, as best shown in FIG. 3, the circumference of body member 22 is symmetrical about a central longitudinal axis 38 and a central transverse axis 39. In particular, body member 22 has straight side peripheral edges 32,33 connected to longitudinal peripheral edges 28, 29. Each of longitudinal peripheral edges 28, 29 comprises a relatively flat central portion 40 which tapers towards side peripheral edges 32, 33 (represented by curved portions 41), convex portions 42, straight angular portions 44 and straight portions 46. Straight portions 46 are connected to and are substantially perpendicular to straight side peripheral edges 32, 33. Straight portions 46 and central portion 40 generally lie in the same horizontal plane. The shape of the illustrated embodiment provides certain advantages discussed later but in general, body member 22 may have other shapes (such as a rectangular shape, an oval shape or a polygonal shape, for example). In the illustrated embodiment, as best shown in FIGS. 2 and 4, body member 22 has generally planar longitudinal and transverse profiles. However, body member 22 may have other profiles, such as a slightly concave longitudinal side profile to facilitate bending of body member 22.

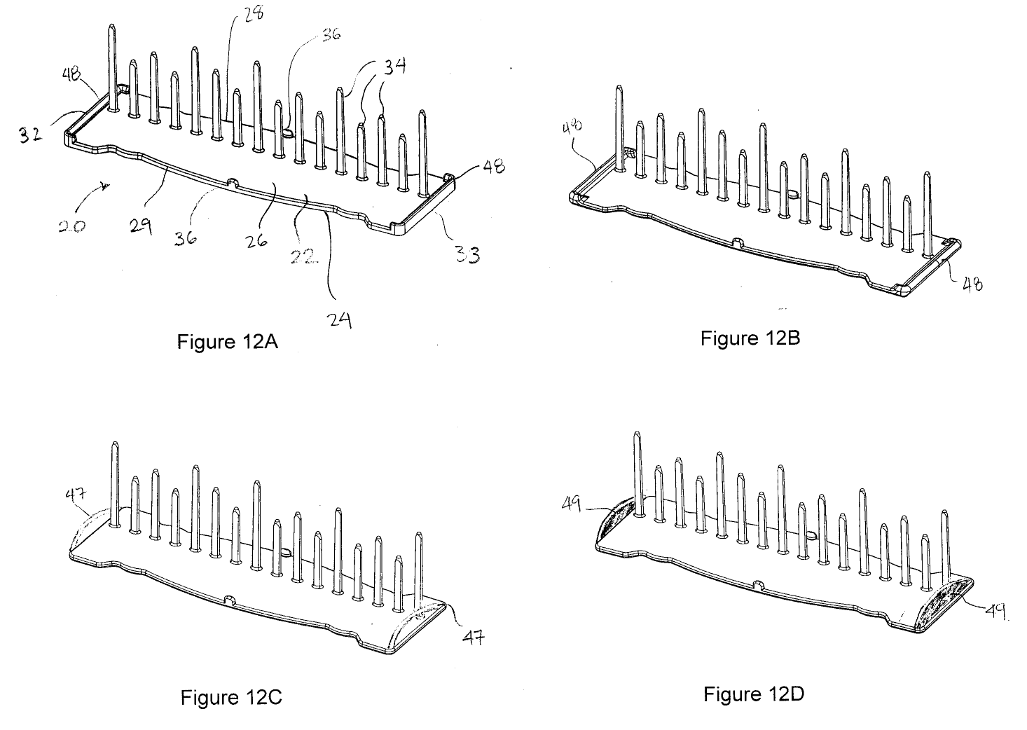

As shown in FIG. 12A, body member 22 may also have one or more lips 48 extending entirely or partially around its peripheral edges. In the illustrated embodiment, lips 48 extend along side peripheral edges 32, 33 and project from inner surface 26. As shown in FIG. 12B, lips 48 may have blunted or rounded edges. In other embodiments, lips 48 may extend along longitudinal peripheral edges 28, 29, in which case tabs 36 may form a part of lips 48. As shown in FIGS. 12C and 12D, instead of lips 48, some embodiments may comprise piping portions 47 or solid portions 49 formed along side peripheral edges 32, 33 and projecting from inner surface 26. Piping portions 47 and solid portions 49 may have a variety of shapes. In the illustrated embodiment, they have an arcuate shape.

In the illustrated embodiment, teeth 34 are generally perpendicular to inner surface 26 and uniformly spaced apart. Teeth 34 are also aligned along a longitudinal axis 50 of body member 22 that is offset from central longitudinal axis 38. However, teeth 34 may also lie along central longitudinal axis 38 or individual or groups of teeth 34 may not be aligned along any longitudinal axis. In addition, teeth 34 do not have to be uniformly spaced apart. In an alternative embodiment, teeth 34 are not perpendicular to inner surface 26; instead, angle α or angle β (FIG. 4) may be an acute angle which would assist in retention of pills on a shelf formed by teeth 34 as discussed below.

In the illustrated embodiment, teeth 34 have varying lengths, ranging from short teeth 51, intermediate teeth 52 and long teeth 53. In general, however, teeth 34 may be of uniform length or vary between two or more different lengths, as long as teeth 34 can be transformed into a shelf when inserted into a container as discussed below. Teeth 34 are shown with tapered ends. However, this shape is not necessary and teeth 34 may have blunt or rounded ends, for example. In the illustrated embodiment, there is one tab portion 36 located in central portion 40 of each of longitudinal peripheral edges 28, 29. Like teeth 34, tabs 36 extend outwardly from inner surface 26. As stated above, tabs 36 may form part of lips 48 if lips 48 extend along either or both of longitudinal peripheral edges 28, 29.

Device 20 may be made of plastic or other bendable resilient material. In some embodiments, device 20 comprises a single piece of injection molded plastic. A variety of different plastics may be used, for example, Nylon 66 or Delrin® 500P. Plastic is advantageous because it is relatively inexpensive, deformable and generally non-reactive.

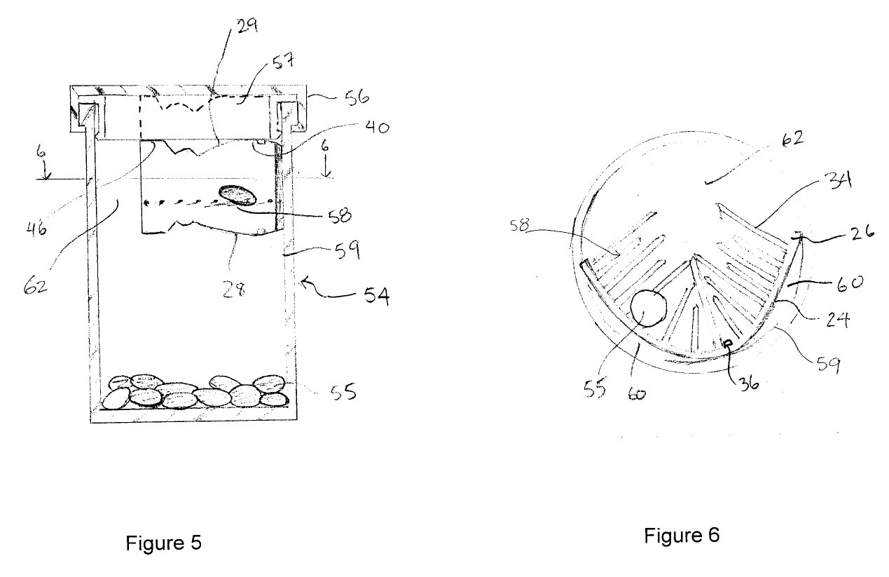

The operation of dispensing device 20 is now described with reference to FIGS. 5 and 6. FIG. 5 shows a container 54 having a lid 56 for storing objects 55. Some lids may include an insert 57 which is used to achieve a more secure closure of container 54 with lid 56. Device 20 is inserted into container 54 by first bending side peripheral edges 32, 33 towards each other. This may be done by grasping side peripheral edges 32, 33 with the fingers and thumb of one or both hands. Alternatively, if side peripheral edges 32, 33 have lips 48, piping portions 47 or solid portions 49 formed on them, then the user may grasp the outward facing surfaces of these structures. Lips 48, piping portions 47 or solid portions 49 prevent side peripheral edges 32, 33 from digging into a user's fingers and thumb when the user applies force to bend device 20.

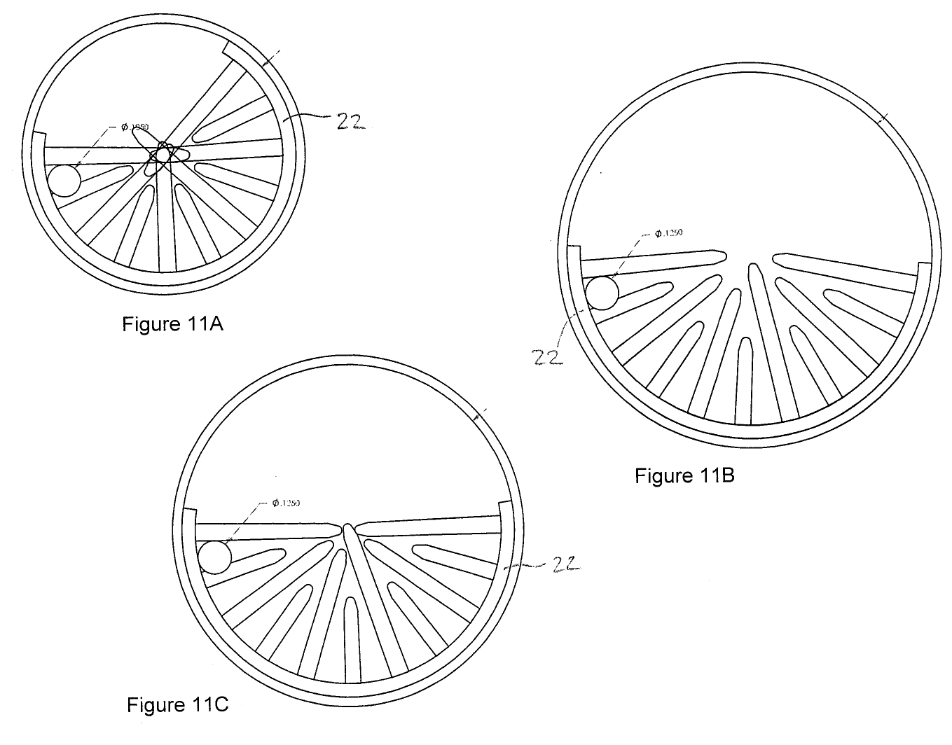

By bending peripheral edges 32, 33 towards each other, this causes body member 22 to take on a circular shape and teeth 34 to extend generally radially from inner surface 26. Device 20 is bent so that it has a radius less than that of container 54. Device 20 can then be placed into the opening of container 54 with either one of longitudinal peripheral edges 28 or 29 entering the container first. Due to the resilient nature of body member 22, body member 22 will spring back and outer surface 24 will engage the inside wall 59 of container 54 in a friction fit. Device 20 will extend partially around inside wall 59 (FIG. 6). In the illustrated embodiment of FIGS. 1-5, only a portion of outer surface 24 will engage inside wall 59 in a friction fit. The portions of outer surface 24 which do not engage inside wall 59 defines spaces 60 between inside wall 59 and outer surface 24. In other embodiments, the entire outer surface 24 engages inside wall 59 in a friction fit and can also be used with different sized containers (FIGS. 11A-11C).

Device 20 is then pushed into container 54 either with the fingers or by replacing lid 56 on container 54. The relatively flat surfaces provided by central portion 40 and straight portions 46 provide a platform for the inner surface of lid 56 to press against when lid 56 is placed on container 54. This causes device 20 to be pushed into container 54 until the appropriate height of device 20 within container 54 is obtained. Specifically, if lid 56 has insert 57, then portions of either longitudinal peripheral edges 28, 29, namely central portion 40 and straight portions 46 will lie flush against insert 57. If lid 56 does not have an insert, then portions of either longitudinal peripheral edges 28, 29, namely central portion 40 and straight portions 46 will lie flush against the inner surface of lid 56, as shown in dashed lines in FIG. 5.

Once device 20 is installed in this manner, teeth 34 form a shelf 58 in container 54 and an opening 62 is defined between shelf 58 and the inside wall of container 54. When whichever is the upper angle, angle α or angle β (FIG. 3), is an acute angle such that teeth 34 of installed device 20 point towards lid 54, this creates an upwardly-angled shelf (not shown) for better retention of objects 55 on the shelf.

Once device 20 is installed, at least one object 55 can then be removed as follows. Container 54 with closed lid 56 is inverted. This causes at least one object 55 to pass through opening 62. When container 54 is partially or fully righted, object 55 is captured and retained by shelf 58. Lid 56 is removed and object 55 is taken out of container 54.

Once container 54 is empty or whenever it is desired to remove device 20, device 20 may be removed by grasping tab 36 or lip 48, if lip 48 is formed along either longitudinal peripheral edges 28, 29, with a fingernail or fingertip and pulling device 20 out of container 54. Device 20 may also be removed by holding onto the outermost teeth 34 of shelf 58 and pulling device 20 out of container 54. Device 20 may then be inserted into another container.

In the illustrated embodiment, teeth 34 are aligned along longitudinal axis 50 which is offset from central longitudinal axis 38. By aligning teeth 34 along axis 50, this provides for two possible shelf heights when device 20 is inserted into container 54. When longitudinal peripheral edge 28 is inserted into container 54 first (as shown in FIG. 5), this provides for a lower shelf height in upright container 54, which allows larger objects to be captured and retained on shelf 58. When longitudinal peripheral edge 29 is inserted into container 54 first (not shown), this provides for a higher shelf height in upright container 54 and can be used for smaller objects. The longitudinal offset alignment of teeth 34 in conjunction with lid 56 or insert 57 will determine how far device 20 is inserted from the top of container 54. Tabs 36 and/or lip 48, if lip 48 is formed along either longitudinal peripheral edges 28, 29, may also assist in inserting device 20 into container 54 by engaging lid 56 or insert 57. When insert 57 is present, spaces 60 ensure that portions of longitudinal peripheral edge 28 or 29 are spaced apart from inside wall 59 and will engage insert 57 to ensure that device 20 will be pushed down into container 54 by insert 57.

In the illustrated embodiment of FIGS. 1-4, the tapered shape of central portions 40 which form curved portions 41 ensures that device 20 bends about a transverse central region. Convex portions 42 tends to nullify twisting forces when bending device 20 and thereby adds stability to device 20. Straight angular portions 44, straight portions 46 and side peripheral edges 32, 33 provide fingerholds to allow device 20 to be more easily grasped. Fingerholds may also be provided by lips 48, piping portions 47 or solid portions 49. The extended length of side peripheral edges 32, 33, relative to the length of device 20 between opposing curved portions 42, also provides for increased contact between device 20 and inside wall 59. This results in greater support for device 20 when inserted in container 54.

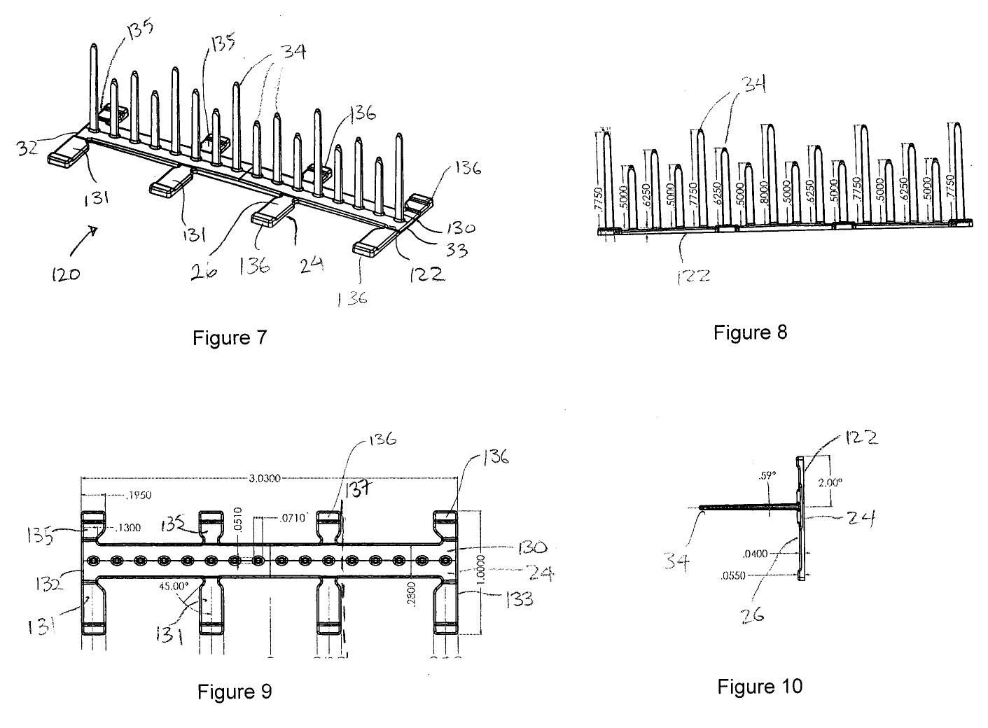

FIGS. 7-10 depict a dispensing device 120 according to another embodiment of the invention. Dispensing device 120 is substantially similar to dispensing device 20, except that dispensing device 120 comprises a body member 122 that is different from body member 22 of device 20. Body member 122 comprises a longitudinal member 130, first transverse members 131 and second transverse members 135.

In the illustrated embodiment, longitudinal member 130 is rectangular shaped. However, longitudinal member 130 may have other shapes. In the illustrated embodiment, first transverse members 131 are longer than second transverse members 135. However, first and second transverse members 131 and 135 may be of the same length. Tabs 136 extend outwardly from inner surfaces of first and second transverse members 131 and 135. In the illustrated embodiment, four first transverse members 131 and four second transverse members 135 are shown. However, device 120 may have two or more of each of first and second transverse members 131 and 135.

The operation of device 120 is substantially the same as for device 20. Device 120 is grasped by the side peripheral edges 32, 33 and the outermost first and second transverse members 131, 135 using the fingers and thumb of one or both hands. Side peripheral edges 32, 33 are bent towards each other such that body member 120 has a circular shape with a radius less than that of container 54. Device 120 is then inserted into container 54 with either first transverse members 131 or second transverse members 135 entering container 54 first. Due to the resiliency of body member 122, body member 122 springs back to engage inside wall 59 in a friction fit. Device 120 extends partially around inside wall 59. The entire outer surface 24 may engage inside wall 59 in a friction fit as shown in FIG. 11 or only a portion of outer surface 24 may engage inside wall 59 in a friction fit as with device 20 and shown in FIG. 6. Once device 120 is at least partially inserted into the opening of container 54, device 120 may be pushed down into the container using the hand or with lid 56 as described above for device 20.

Once installed in container 54, teeth 34 of device 120 forms a shelf 58 and an opening is defined between shelf 58 and container 54. The operation of device 120 to dispense an object from container 54 is the same as for device 20. The longitudinal offset alignment of teeth 34 achieved by the unequal lengths of first and second transverse members 131, 135 results in two possible shelf heights for shelf 58 when inserted in container 54. To remove device 120 from container 54, any one of tabs 136 closest to the opening of container 54 may be grasped using a fingernail or fingertip to pull device 120 out of container 54. Device 120 may also be removed by holding onto the outermost teeth 34 of shelf 58 and pulling device 120 out of container 54.

Device 120, like device 20, may be used with containers of various sizes. In addition, the size of device 120 may be modified to fit smaller containers by cutting longitudinal member 130 along line 137 shown in FIG. 9.

As will be apparent to those skilled in the art in light of the foregoing disclosure, many alterations and modifications are possible in the practice of this invention without departing from the spirit or scope thereof. For example:
In the embodiments described above, the dispensing devices may be used to dispense pharmaceutical products such as medications in the form or pills, capsules or tablets. However, the dispensing devices may be used to dispense other objects such as candies, chocolates, beads, nuts, bolts, nails, etc.
In some embodiments, the dispensing devices may be made of different colours, so as to be highly visible and correspond to different types of medication. This is useful where the containers are transparent or translucent and the colour of the dispensing device can be readily seen through the container.
   Accordingly, the scope of the invention is to be construed in accordance with the substance defined by the following claims.

What is claimed is:

1. A device for dispensing at least one object from a container, the device comprising:
an elongate body member, the body member having an outer surface for following at least partially an inside wall of the container when the device is inserted into the container and having at least a portion of the outer surface engaging the inside wall of the container in a friction fit; and
a plurality of teeth extending from an inner surface of the body member at spaced apart locations, the teeth extending in a substantially radial direction to form a shelf when the body member is inserted into the container,
wherein an opening is defined between the shelf and the inside wall of the container when the device is inserted into the container, the opening sized to allow passage of the at least one object from a bottom portion of the container through the opening when the container is inverted, the at least one object being retained on the shelf when the container is at least partially righted.

2. A device according to claim 1 wherein the body member is formed of a bendable resilient material and is bendable to allow the body member to be inserted into the container.

3. A device according to claim 2 wherein the body member is formed of plastic.

4. A device according to claim 2 wherein the body member comprises opposed longitudinal peripheral edges and opposed side peripheral edges.

5. A device according to claim 4 wherein the opposed side peripheral edges are of a shape selected from the group consisting of: a straight edge, a rounded convex shape, a rounded concave shape, and a polygonal shape.

6. A device according to claim 5 wherein the opposed longitudinal peripheral edges are of a shape selected from the group consisting of: a straight edge, a rounded convex shape, a rounded concave shape, and a polygonal shape.

7. A device according to claim 5 wherein the opposed longitudinal peripheral edges are of a shape comprising a convex curved central portion tapering towards the side peripheral edges, which are connected to convex curved side portions, which are in turn connected to straight angular portions, which are in turn connected to straight edges and the straight edges are perpendicularly connected to the side peripheral edges.

8. A device according to claim 7 comprising a fingerhold region formed by the straight angular portions, the straight edges and the side peripheral edges.

9. A device according to claim 2 comprising at least one tab formed on a longitudinal peripheral edge of the body member, the tab extending outwardly from the inner surface of the body member.

10. A device according to claim 2 comprising at least one lip portion formed on a longitudinal or side peripheral edge of the body member, the lip portion extending outwardly from the inner surface of the body member.

11. A device according to claim 2 comprising a piping portion formed on each of the side peripheral edges of the body member.

12. A device according to claim 2 comprising a solid portion formed on each of the side peripheral edges of the body member.

13. A device according to claim 2 wherein the body member comprises a longitudinal portion, a plurality of first transverse portions extending from a first longitudinal peripheral edge of the longitudinal portion, and a plurality of second transverse portions extending from a second longitudinal peripheral edge of the longitudinal portion.

14. A device according to claim 13 wherein pairs of first and second transverse portions are transversely aligned.

15. A device according to claim 14 wherein the first and second transverse portions have different lengths.

16. A device according to claim 13 comprising tabs formed at end portions of at least one of the plurality of first transverse portion and at least one of the plurality of second transverse portions, the tabs extending outwardly from an inner surface of the end portions.

17. A device according to claim 14 wherein the size of the device may be adjusted by removing a portion of the longitudinal portion adjacent one of the pairs of transversely aligned first and second transverse portions.

18. A device according to claim 1 wherein the plurality of teeth are uniformly spaced apart.

19. A device according to claim 1 wherein the plurality of teeth are aligned along a longitudinal axis of the body member.

20. A device according to claim 18 wherein the longitudinal axis is offset from a central longitudinal axis of the body member.

21. A device according to claim 18 wherein the plurality of teeth are of varying lengths.

22. A device according to claim 20 wherein the varying lengths comprise two or more different lengths.

23. A device according to claim 21 wherein each one of the plurality of teeth is of a different length relative to an adjacent one of the plurality of teeth.

24. A device according to claim 1 wherein the teeth are perpendicular to the elongate body member.

25. A device according to claim 1 wherein the teeth form an acute angle with the elongate body member such that an upwardly sloping shelf is formed when the device is inserted into the container.
